(19) United States
(12) Patent Application Publication
(10) Pub. No.: US 2006/0277384 A1
(43) Pub. Date: Dec. 7, 2006

(54) Method and apparatus for auditing remote copy systems

(75) Inventors: Yuichi Yagawa, San Jose, CA (US); Junichi Hara, San Jose, CA (US); Tom Attanese, Pennington, NJ (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 11/143,512

(22) Filed: Jun. 1, 2005

(51) Int. Cl. G06F 12/00; G06F 12/16

(52) U.S. Cl. 711/170; 711/162

(57) ABSTRACT

Techniques are described for providing information about the performance of remote copy operations between a primary storage system and a remote storage system. Software probes monitor the status of primary storage system WRITE operations and of remote storage system WRITE operations. A comparison provides information about the performance of remote copy operations. The system allows measurement of a consistency time reflecting the approximate time of how far behind the remote copy is from the primary data in terms of WRITE operation time.

### BACKGROUND OF THE INVENTION

This invention relates to storage systems, and in particular to techniques of assuring appropriate performance of remote copy systems in such storage systems.

Large organizations throughout the world now are involved in millions of transactions which include enormous amounts of text, video, graphical and audio information. This information is being categorized, stored, accessed, and transferred every day. The volume of such information continues to grow. One technique for managing such massive amounts of information is to use storage systems. Conventional storage systems include large numbers of hard disk drives operating under various control mechanisms to record, mirror, remotely backup, and reproduce this data. The rapidly growing amount of data requires most companies to manage the data carefully with their information technology systems, and to assure appropriate performance within such systems.

One common occurrence in the management of such data is the need to assure its preservation by making remote copies of the information in a location away from a primary or production site. Maintaining such records in a remote site helps assure the owner of the data that the data will be available even if there are natural disasters or other unexpected events which occur at the primary site and destroy the data there. By having stored the data in a remote location, protection is also provided in the event of failures in the primary storage system, as well as other events. Should an event occur at the primary site, the data from the remote copy operation can be retrieved and replicated for use by the organization, thereby preventing data loss or the need to recreate the data at considerable cost and delay.

Typically the data at the remote site (the “remote copy”) is remotely copied to be stored at that site via a communications network which is either dedicated to the transmission of data between the primary site and the remote site, via the Internet, or by other means. Of course, because the remote site is, by definition, located at a distance from the primary site to provide enhanced data protection, there is a delay between the time the data is stored at the primary site and the time the data is transmitted to and stored at the remote site. Depending upon the bandwidth of the connection and the particular equipment at the remote site, this delay can be significant. Examples of storage-based remote copy technology as provided by leading vendors are Hitachi TrueCopy™, EMC SRDF™, and IBM PPRC™.

To date, however, there has been no satisfactory means available for auditing the remote copy and the remote site to determine its currency with respect to the fresh data being provided to the primary site. Users of storage systems must assure that the remote copy is always properly operating, because the timing of and nature of a particular disaster will be unknown. In addition, the Securities and Exchange Commission is now issuing standards with respect to practices for maintaining business records and the like, some of which require certain users to execute various disaster recovery tests periodically. As a result, there is a growing need for users to have storage systems and software which assure the remote copy systems are operating correctly, and which determine the consistency time, i.e., the time that describes how far behind the remote copy is from the primary data in terms of WRITE operation time.

Some of the existing solutions, for example, IBM's PPRC CQUERY command enable assuring the remote site is operational. This solution may be satisfactory in simple implementations; however, the remote copy configuration environment has become more complex in which various applications cause an inconsistent WRITE workload. Furthermore, because of limited budgets, users want to utilize storage systems as efficiently as possible, and with minimum network costs. These network costs can rise when high network bandwidth is required to provide remote copy functionality. Accordingly, a need has arisen for monitoring remote copy operations and reporting to users so that they can understand their storage systems, and particular the remote copy operations therein, better than before.

A further issue with respect to remote copy operations is the need to satisfy various recovery objectives, and in particular to assure that the remote copy satisfies particular recovery objectives. The Storage Networking Industry Association has defined two recovery objectives. The recovery point objective (RPO) is the maximum desired time period prior to a failure or a disaster during which changes to the data may be lost as a consequence. Data changes preceding the failure or disaster by at least this time period are preserved by a recovery. In other words, changes to the data made later than this time will not be reflected in the remote copy. A zero value is equivalent to no loss of data. In general, the consistency time indicates RPO, which is how much time of WRITE data potentially could be lost if the production storage system goes down.

A second established definition for a recovery objective is the recovery time objective (RTO). This is the maximum desired time period required to bring one or more applications and its associated data back to a correct operational state. Because a major factor of RTO is the time to restart a server and its applications, it is not necessarily a desirable measure of the quality of remote copy operations.

### BRIEF SUMMARY OF THE INVENTION

The method and apparatus of this invention provides a technique for auditing a remote copy system to determine if the system is satisfying particular recovery objectives. This invention provides a technique by which host input/output (“I/O”) (mainly WRITE) operations are monitored and compared with corresponding operations to a remote copy system. It thereby allows a determination of the relationship between the data presently being stored at a remote copy location, and the current data being operated upon by the processor. As a result, the user obtains a measure of the time difference between the two, and therefore a measure of the extent to which data would be lost if the primary storage system failed and the user were forced to rely entirely upon the remote system. It further allows calculation of a parameter we refer to as consistency time, which is an estimate of how far behind the remote copy is from the primary data, as measured in terms of WRITE operation time.

In a preferred embodiment, a method of implementing this invention includes providing a storage system coupled to a host, with primary storage media at a primary site and remote storage media at a remote site. WRITE operations of the host are monitored at first times, and at corresponding times, WRITE, COPY or APPLY operations of the remote site are monitored. From a comparison of the monitored information, a consistency time, reflecting the delay between storage of data at the primary site and storage of data at the remote site is obtained, thereby providing a measure of the performance of the remote system.

In a preferred implementation of the system, a first probe is used to monitor host WRITE operations, either at the host or at the storage system, at first times, a remote copy probe is used to monitor remote copy operations at the first times, and a remote copy auditor coupled to receive the data from the first probe and the remote copy probe. The auditor compares the information from the two to thereby provide information about the time delay between operations to the primary storage system and the remote storage system.

The system described can be implemented with particular facility in a journal remote copy system in which all changes being made to a primary volume are written to a journal volume before being stored to the primary volume. The journal data is also sent to the remote site and used to update a remote volume there.

The consistency time can be calculated by measuring the number of WRITE operations to be copied in the primary system and dividing that by the average number of WRITE operations per second. Alternatively, the size of the WRITE data to the primary journal can be measured. Dividing that information by the average throughput provides an approximation of the consistency time.

### BRIEF DESCRIPTION OF THE DRAWINGS

FIG. 1 is a block diagram illustrating the overall architecture of a remote copy system;

FIG. 2 is a diagram of a host probe;

FIG. 3 is a diagram of a remote copy probe;

FIG. 4 is a table of the remote copy workload from a history database;

FIG. 5 is a flowchart illustrating one method of calculating consistency time;

FIG. 6 is a flowchart of a method of calculating a primary journal volume usage ratio;

FIG. 7 is a chart illustrating a graphical user interface for a remote copy manager; and

FIG. 8 is a flowchart of another method of calculating consistency time.

### DETAILED DESCRIPTION OF THE INVENTION

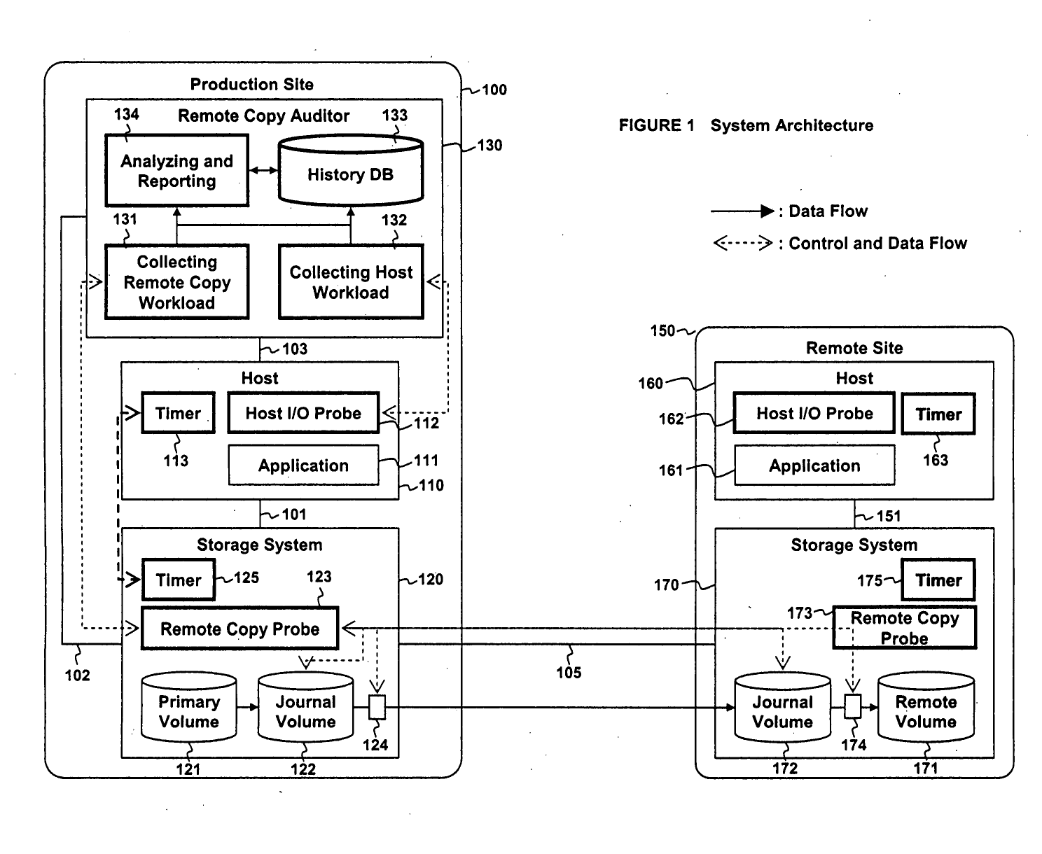

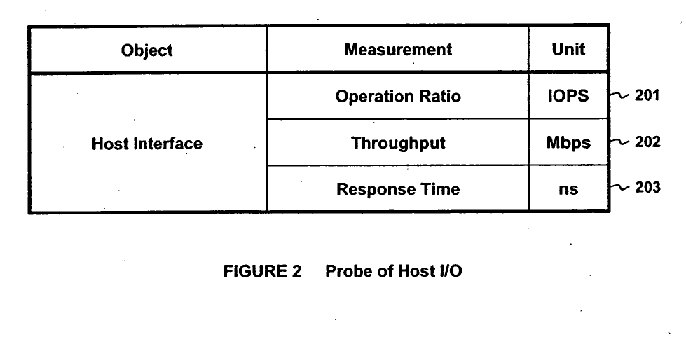

FIG. 1 is a block diagram of a storage system implementing a preferred embodiment of the invention discussed herein. Generally, the overall system includes a primary or production site 100 and a secondary or remote site 150. Although only one remote site 150 is depicted, as many remote sites as desired may be provided. The primary site includes a host 110, a storage system 120, and a remote copy auditor 130. In a conventional manner the host 110 is coupled to the storage system 120 via a Fibre Channel interface 101, FICON, ESCON, or network attached storage based on NFS or CIFS. The host runs applications 111, for example, a database, which issue input/output operations to the storage system 120 via an operating system. The host may also include other software, such as heartbeat software to detect continued operations of the production host 110 and the corresponding remote host 160. The software described enables the primary host and the remote host to execute failover or failback operations when necessary. Host 110 also includes a probe 112, typically a software program, which monitors I/O (mainly WRITE) workload within the host 110. The particular measurements taken by the probe 112 are discussed in conjunction with FIG. 2 below. The host 110 typically also includes a timer 113 which, as will be discussed, provides a reference timing signal for a corresponding timer 125 in the storage system. If desired, a single timer may be used in one location or the other, and coupled to the other of the host or storage system in an appropriate manner. The storage system 120 is a typical storage system having a remote copy capability. For example, the Hitachi TagmaStore universal storage platform, the Hitachi Lightening 9900 V series, the Hitachi Thunder 9500 V series, as well as other systems provide remote copy capability. The remote copy operations may be asynchronous or synchronous to the data operations made to the primary volume.

Although other techniques may be used, the system depicted in FIG. 1 assumes a journal-based remote copy capability. In journal-based remote copy, WRITE operations from host 110 are stored into the journal volume as well as applied to the primary volume, and then the journal data is sent to the secondary or remote storage system through a wide area storage network 105. Examples of its physical network are Dark Fibers, DWDM, ATM, SONET and so on, and examples of its protocol are FibreChannel, FICON, ESCON, FCIP, iFCP, iSCSI and so on. The network may include extenders that expand network protocols for long distance. Journal-based remote copy capability is discussed in commonly-assigned copending U.S. patent application Ser. 10/603,076 entitled “Data Processing System Including Storage Systems.”

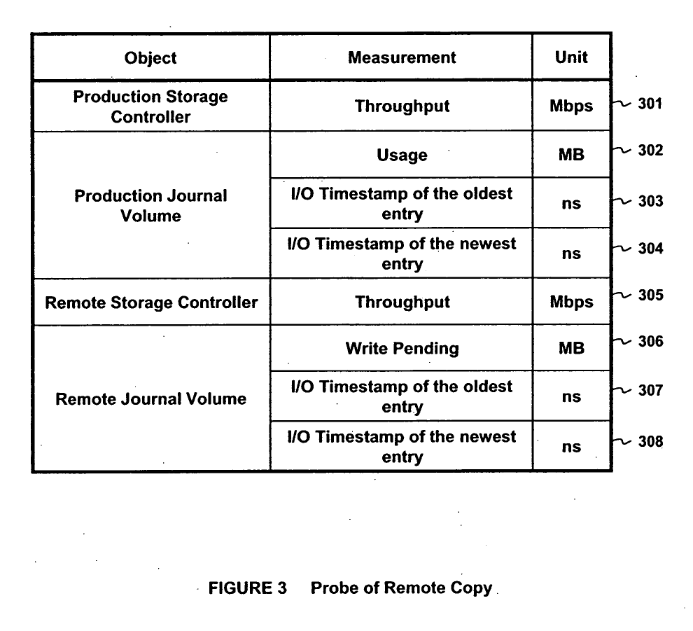

Storage system 120 also includes a probe 123 to measure the remote copy workload within the storage system. The particular measurements taken by the probe are discussed in more detail later in conjunction with FIG. 3, however, the measurements are generally depicted in FIG. 1 using dashed lines. The dashed lines illustrate the probe 123 addressing a journal volume 122 and a copying process 124 in the production site and a similar volume 172 and an applying process 174 in the remote site. The resulting information can be stored, as shown by block 131. In addition, as mentioned above, a timer 125 may also be provided in the storage system 120 to enable synchronization with the host for purposes of the remote copy auditing function described herein.

In an alternative embodiment, rather than measuring the host WRITE performance, probe 112 is placed in the storage system. In this implementation, it measures storage I/O operations from the point of view of the storage system 120. In other words, probe 112 is placed in the storage system and monitors the WRITE operations received by the storage system, rather than those sent by the host. In such implementations, there is no need for timer 113 or probe 112 to be situated in the host. This embodiment also eliminates the need for synchronization of timers, because timer 125 can be used for both the probe of received host I/O operations and the remote copy operations.

As also shown, the primary site 100 includes a remote copy auditor 130. The remote copy auditor 130 provides the capability of reporting and analyzing remote copy operation status and performance. The auditor 130 enables users to determine causes or errors, or impediments in remote copy operations for enabling greater efficiency. Generally the auditor 130 is implemented as software on a computer system, for example, a server or a maintenance computer coupled to the storage system 120. The remote copy auditor 130 collects the host workload 132 from the host probe 112. It also collects remote copy workload information from probe 123 in storage system 120. The collected information is stored in a history database 133, which may itself comprise a volume in the storage system 120. The particular information collected and stored is discussed below. The host and the remote copy auditor are preferably connected using a network, for example a TCP/IP protocol-based local area network 103. The auditor may communicate with the storage system through the storage area network (102) itself, or a TCP/IP protocol-based local area network (102). There may be an implementation in which the auditor resides on the same host as the application.

Remote site 150 also typically contains a remote host 160 and a remote storage system 170. More than one storage system may be employed, but no hosts need be employed to reduce cost. The remote storage system 150 is similar to the primary storage system 120, except that it receives the journal information from the primary storage 120 and stores that journal information in journal volume 172. The changes written into the journal volume are then applied to the remote volume 171. The remote host 160 itself is not an essential element of the remote site. It operates typically only when the workload of host 110 fails over to site 150. In this case, the host I/O probe 162 and host application 161, as well as timer 163, will operate, otherwise, they may be quiescent. As described with respect to the primary site, the host and the storage system in the remote site are coupled via the communications channel 151. The remote host may also execute the same application 161 as the application 111, for example, a database program.

The embodiment depicted in FIG. 1 employs journal volumes for providing the remote copy operations. Such journal volumes are equivalent to, and can be replaced with, a cache memory or suitable buffer. Such a memory or buffer will maintain a record of data operations to the primary volume 121 and the remote volume 171. FIG. 1 also depicts another embodiment in which the remote host includes its own probe 162 and the remote copy includes its own probe 173. In this case functionality is the same as described above where the probe is not within the host.

FIG. 2 is a table illustrating the information collected by the host I/O probe 112. As shown, the object of the probe is the host interface. The measurements taken preferably include a measure of the operation ratio 201, for example, WRITE operations per second measured in IOPS (WRITE operations per second), throughput 202, for example, WRITE throughput measured in Mbps (megabits or megabytes per second), and response time 203, for example, WRITE operation response time measured in nanoseconds. Of course, other information can be collected, and the information can be presented in other formats such as ratios of a maximum capability, etc. The parameters may be measured in terms of logical units, such as applications, application groups, host partitions, copy groups, etc.

FIG. 3 is a diagram illustrating the remote copy probe 123. Probe 123 measures the throughput 301 of the production storage controller. For example, as the mark 124 indicates in FIG. 1, the probe 123 measures the amount of WRITE data transferred from the storage controller to the remote storage system per second (remote copy throughput) in Mbps. As allow in Fig.1 indicates, it also measures around the production journal volume 302. One measurement is the usage of the production journal volume 302 by indicating the amount of the journal in the volume in megabytes. Assuming that every WRITE operation has a time stamp placed on it by the server at the time of issuance, or by the storage system at the time of receipt, the time stamp of the oldest entry awaiting action 303 is also measured. Similarly, the probe collects the time stamp of the newest entry 304 in the production journal volume.

Remote copy probe 123 also collects information from the remote storage controller about its throughput 305 and from the remote journal volume 172. An example of the throughput 305 is, as a mark 174 indicates, the amount of data applied to the secondary volume per second (apply throughput) in Mbps. As allow indicates, it also measures around the remote journal volume 172. The remote journal volume information collected includes the amount of data pending write operations 306, typically in megabytes, the I/O time stamp 303 of the oldest entry in the remote journal volume 172, and the time stamp of the newest entry 304 in that journal volume. The remote copy probe 123 may access to the remote storage system 170 through the wide area storage network 105 or TCP/IP based wide area network.

As mentioned above, to compare all of the measurements taken from the host probe 112 and the remote copy probe 123, it is necessary to synchronize the timers. To achieve this, timer 113 in the host and timer 125 in the storage system are regularly synchronized. Such synchronization can be performed using a variety of techniques. For example, in a master and slave operation host 110 becomes a master of the timer, and storage 120 receives commands from the host 110. The host regularly issues timer synchronization commands with the exact time to the storage 120. The storage collects the timer information and adjusts the timer 125 as necessary.

An alternative synchronization technique is arbitration. In this case, the host and the storage arbitrate their timers with each other and decide what time should be followed. In yet another implementation, the host and the storage regularly check for the exact time with a trusted third party such as a time stamp authority. The host and the remote then synchronize their timers in that manner. This technology is well known, and commonly referred to as Network Time Protocol (NTP).

Assuming the timers to be synchronized, the remote copy auditor 130 collects the host workload information described in FIG. 2 from probe 112, and saves it to the history database 133. At the same time the auditor 130 provides the information to users as real time monitoring, for example, through an analyzing and reporting module 134. Similarly, the remote copy auditor collects the remote copy workload information described in FIG. 3 from probe 123 and saves it into the database 133. This information may also be provided to users as real time monitoring, for example, through an analyzing and reporting module 134.

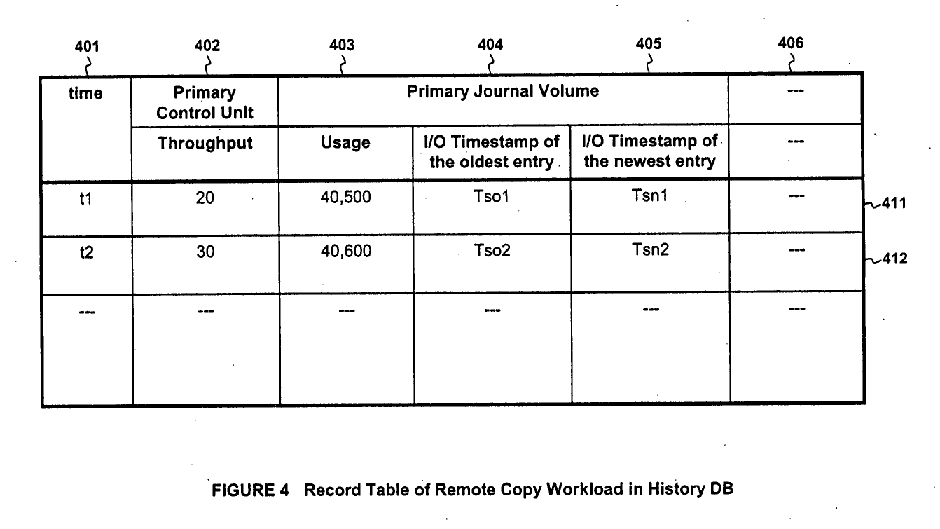

The history database 133 stores the workload information regularly collected from each of the probes. FIG. 4 is an example of such workload records. As column 401 indicates, each record is based upon a measurement of time or interval from the synchronized timers. The remaining information is similar to that collected and described in FIGS. 2 and 3. It includes the primary throughput 402, the usage of a cache or journal volume 403, the time stamp information 404 and 405. In addition, other information as desired can be presented in column 406. For example, once calculated data may be also recorded to avoid redundant calculation.

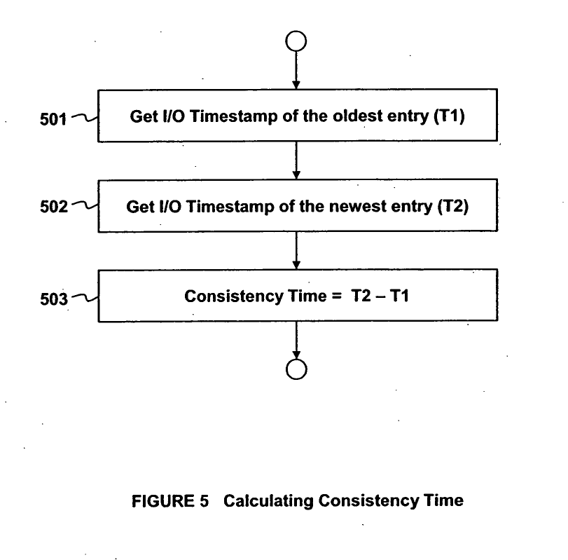

FIG. 5 is a flowchart of a technique for calculating the consistency time, an indication of approximately how much time the remote storage system 170 is behind from the production storage system 120. In other words, the consistency time indicates how much time of WRITE data potentially could be lost if the production storage system 120 goes down, which is RPO. Since all of the copied data on network 105 eventually arrives at the remote storage system 170, the consistency time can be calculated from the difference between the time stamps of the oldest and the newest I/O in the production journal volume 122. The particular manner in which this is done is shown in FIG. 5.

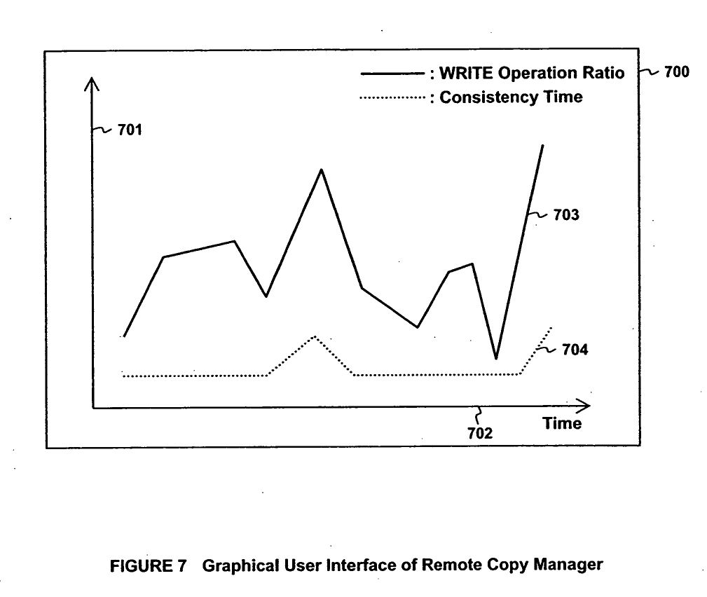

At step 501 the I/O time stamp of the oldest entry 303 at a certain measuring time is retrieved. Then at step 502 the I/O time stamp of the newest entry 304 at the same time is also retrieved. By subtracting the newest from the oldest, the consistency time at that measurement time is determined. The manner in which this is presented to the user will be discussed in conjunction with FIG. 7. In another embodiment, two time stamps collected from the probe 112 or the history database 133 do not have exactly the same time, but are within a minimal time period of each other.

In another technique for calculating the consistency time, the number of WRITE 1,0 operations to the primary (production) journal is measured, and the average number of WRITE 1,0 operations per second is determined. By dividing the later quantity into the former, an approximate consistency time in seconds is determined. Alternatively, the size of the WRITE I/O in the production volume may be measured, then that quantity divided by the average throughput of the WRITE I/O per second to obtain an approximate consistency time in seconds.

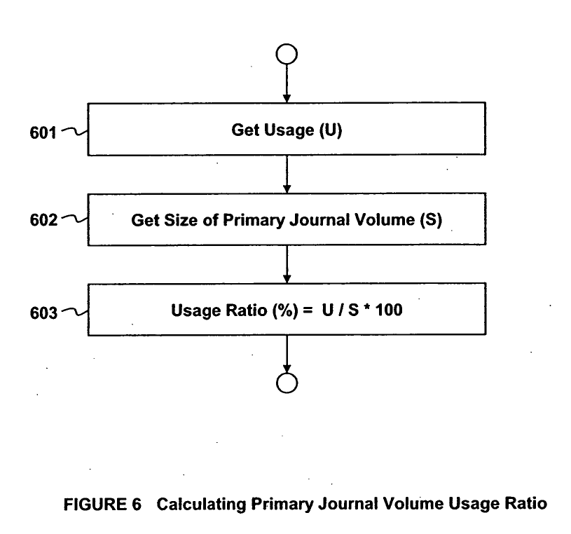

FIG. 6 illustrates the process for calculating remote copy performance. This is a new measure developed by the inventors herein which describes how efficiently the remote copy resources are being used. The basic idea of the calculation is to divide the usage of a particular measurement of time by the total resource size, thereby obtaining a usage ratio. One technique for achieving this is shown in FIG. 6.

As shown in FIG. 6 at step 601, the initial step is that the process retrieves the primary journal volume usage information 302 at a certain measurement time from the probe 123 or the history database 133. In step 602 the size of the primary journal volume 122 is retrieved, for example from a configuration file or other management software. At step 603, the usage is divided by the size, then multiplied by 100 and expressed as a percentage, thereby providing one indication of the performance of the remote copy system. Of course, other determinations may be made of remote copy performance. For example, a production controller throughput ratio can be calculated by comparing the present production controller throughput with the maximum. A similar measure can be made of the remote controller throughput. The remote journal volume usage ratio may be determined, as well as other measures of system performance.

FIG. 7 is an illustration of a user interface for presenting to the user information about the performance of the remote copy operations. As shown there, the WRITE operation ratio (IOPS) 703 and the consistency time 704 are displayed as a function of time. Axis 701 indicates the parameter values, and axis 702 the time. As shown, the consistency time will typically reach a minimum value reflecting uncongested transmission and write times at the remote site. Higher than minimum consistency times indicate diminished performance of the remote copy operation, compared with WRITE operation.

Although these two parameters are discussed in conjunction with FIG. 7, it will be apparent that any desired parameters may plotted and presented to the user as measures of remote copy performance. For example, host throughput and production storage controller throughput (or remote copy throughput) can be displayed to show how efficiently the controllers are operating the remote copy. Production storage controller throughput (or remote copy throughput) and remote storage controller throughput (or apply throughput) may be displayed to show how efficiently the process of applying journal is operating. Host response time may be compared with various throughputs as a measure of asynchronous remote copy. Host throughput, production journal volume usage and remote journal volume write pending may all be presented to show how write I

/O operations impact storage resources.

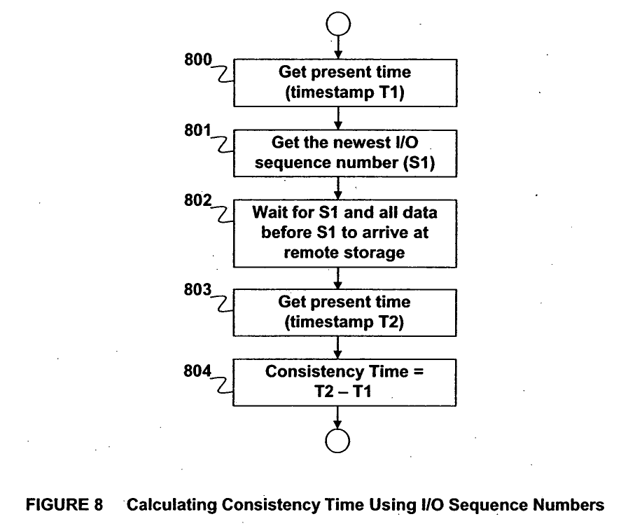

FIG. 8 is a flowchart illustrating another technique for calculating the consistency time. In this case, I/O sequence numbers are used. This implementation is particularly useful if time stamp information is not available for each WRITE entry in the journal volume 122. In such case, the time stamps T1 and T2 can be approximated by using the sequence numbers associated with each entry in the WRITE chain. This process is shown in more detail in FIG. 8. As shown there, at step 800, the present time is retrieved and regarded as a time stamp T1. At step 801, the newest WRITE 10 sequence number S1 from the production journal volume 122 is retrieved. These two steps need to be executed almost synchronously. The process then waits until that all WRITE I/O operations before and with the sequence number SI arrive in the remote storage system 170. At step 803 the process determines that event time (the confirmation of all I/O arrival), and regards that as time stamp T2. The consistency time is then indicated by the difference between T2 and T1.

Some remote copy systems may be configured to have multiple storage systems at multiple sites. In some cases such systems configure more than three storage systems at different locations or sites. Such systems also can be measured using the techniques described herein. In such systems typically one storage system receives I/O from at least one production host, and performance of those may be measured in the same manner as described above (i.e. Host I/O Probe resides in the storage system). Of course, the remote copy probe would need to be capable of accessing each such storage system, and the auditor would need to be aware of the multiplicity of storage systems. In these situations, the host and the storage system may have the same configuration as the host 110 and the storage system 120 discussed above. The other storage systems may have the same configuration as the storage system 170. The difference from the first embodiment is that the probe in the production storage system should have the capability to access multiple storage systems at different locations. Remote copy auditor 130 should be aware of the total number of storage systems at different sites, for example, by having them included in the history database 133.

There is another remote copy system in which the remote copy is operated by the hosts. In this case, a probe of remote copy may exist within the host, and its configuration and function are the same as the probe of remote copy 123 discussed above. Also, there is another remote copy system in which the remote copy is operated by combination of a storage system and a host. An example is IBM XRC(r). In this case, probes of remote copy may be provided at both the storage system and the host. The measurements that those probes collect are the same as the first embodiment. In addition, the timers to which the probes refer should be synchronized in the same way described above.

In a further embodiment, multiple production storage systems and multiple remote storage systems can be employed and their performance measured. In this case, there may be multiple hosts in which probes 112 are provided, and multiple production storage systems in which probe 123 is provided. In this implementation, the remote copy auditor 130 stores measurements from the probes, but maintains the relationship among the multiple storage systems and the multiple hosts. Then the calculations and analysis described in conjunction with FIG. 5, 6 and 7 can be performed on a predefined group basis, like a copy group basis. As an example of FIG. 5, the oldest entry and the newest entry should be found in caches or journal volumes within the group. Also, the timers among the storage systems should be synchronized. Example of synchronizing the timer is using the same host based timer like Sysplex Timer(r) from IBM or using NTP (Network Time Protocol). An example of the group is consistency group that is defined for pairs across multiple storage subsystems. The analysis report, like FIG. 7, can be provided on a group basis.

Although the foregoing has been a description of the preferred embodiments of the invention, it will be understood that these are provided for illustrative purposes only. The scope of the invention may be determined from the appended claims.

What is claimed is:

1. In a storage system coupled to a host, and having primary storage media at a primary site within which primary data are stored, and a remote site having remote storage media at which the primary data is copied, a method of auditing the remote site to assure desired performance comprising:
monitoring WRITE operations to the primary site at first times;
at corresponding times, monitoring WRITE operations of the remote site;
calculating from the monitored information a consistency time reflecting a delay between storage of data at the primary site and storage of data at the remote site to thereby provide a measure of performance of the remote system.

2. A method as in claim 1 further comprising:
repeating the steps of monitoring WRITE operations of the host and at corresponding times, monitoring WRITE operations of the remote site, to thereby obtaining a history of the performance of the remote site; and
storing the history.

3. A method as in claim 1 further comprising displaying the history to a user of the storage system.

4. A method as in claim 1 wherein the step of monitoring WRITE operations to the primary site at first times includes providing a primary probe in the host coupled to a timer.

5. A method as in claim 1 wherein the step of monitoring WRITE operations to the primary site at first times includes providing a primary probe in the primary site coupled to a timer.

6. A method as in claim 1 wherein the step of at corresponding times monitoring WRITE operations of the remote site is performed by providing a probe in the primary site coupled to the remote site.

7. A method as in claim 1 wherein the step of calculating from the monitored information a consistency time reflecting a delay between storage of data at the primary site and storage of data at the remote site comprises comparing a timestamp of an oldest entry awaiting action at the remote site with a newest entry awaiting action at the primary site.

8. A method as in claim 1 wherein the step of calculating from the monitored information a consistency time reflecting a delay between storage of data at the primary site and storage of data at the remote site comprises determining the time between a write operation to the primary site and that same write operation at the remote site.

9. In a storage system coupled to a host, and having primary storage media at a primary site within which primary data are stored using a primary journal volume, and a remote site having remote storage media at which the primary data is copied using a remote journal volume, a method of auditing the remote site to assure desired performance comprising:
monitoring WRITE operations to the primary site at first times;
at corresponding times, monitoring WRITE operations of the remote site;
calculating from the monitored information a performance measure by determining use of the primary journal volume.

10. In a storage system coupled to a host, the storage system including a primary storage system and a remote storage system, a remote copy auditor comprising:
a first probe for monitoring WRITE operations to the primary storage system at first times;
a remote copy probe for monitoring remote copy operations at the first times; and
a remote copy auditor coupled to each of the first probe and the remote copy probe, the auditor for comparing information from the first probe and the remote copy probe to thereby provide information about a time delay between operations to the primary storage system and the remote storage system.

11. A system as in claim 10 wherein the remote auditor stores information about the time delay as a function of time to thereby obtain a history of the performance of the remote site.

12. A system as in claim 10 further comprising a display for displaying the history.

13. A system as in claim 10 wherein each of the first probe and the remote copy probe are located in primary storage system and are coupled to a timer for providing the first times.

14. A system as in claim 10 wherein the step of monitoring WRITE operations to the primary site at first times includes providing a primary probe in the primary site coupled to a timer.

15. A system as in claim 10 wherein:
the primary storage system includes a primary volume and a primary journal volume, the primary journal volume for storing a record of the data operations to the primary volume;
the remote system includes a remote volume and a remote journal volume, the remote journal volume for storing a record of the data operations to the remote volume;
each data write operation includes a timestamp to indicate time of writing to the primary storage system; and
the remote copy auditor compares timestamps of data written to the primary journal volume with timestamps of data written to the remote journal volume to obtain a measure of system performance.

16. A system as in claim 15 wherein the remote copy auditor further includes a display for displaying to a user a time varying indication of a comparison of the timestamps of the data being written to the primary journal volume with the timestamps of the data being written to the remote journal volume.

17. In a storage system coupled to a host, and having primary storage media at a primary site within which primary data are stored, and a remote site having remote storage media at which the primary data is copied at a later time, a graphical user interface for displaying the time varying performance of the system to provide a measure of remote copy performance.

18. A system as in claim 17 wherein the measure of remote copy performance comprises a graph upon which a time delay between a write to the primary storage media and a corresponding write to the remote storage media is displayed as a function of time.

19. A system as in claim 18 further comprising also displaying an indication of throughput to the primary storage system on the graph.

20. A system as in claim 18 further comprising also displaying at least one of production storage controller throughput, remote copy throughput, remote storage controller throughput, host response time, host throughput, production journal volume usage and remote journal volume write pending may all be presented to show how write I/O operations impact storage resources.

21. In a storage system coupled to a host, and having primary storage media at a primary site within which primary data are stored in accordance with entries in a primary journal volume, and a remote site having remote storage media at which the primary data is copied in accordance with a remote journal volume, a method of determining an approximate consistency time comprising:
calculating a number of write operations sent to the primary journal volume which have not yet been written to the remote storage media;
calculating an average number of write operations per unit time;
using the information calculated in the two preceding steps, determining an approximate consistency time.

22. In a storage system coupled to a host, and having primary storage media at a primary site within which primary data are stored in accordance with entries in a primary journal volume, and a remote site having remote storage media at which the primary data is copied in accordance with a remote journal volume, a method of determining an approximate consistency time comprising:
calculating a size of the write operations in the primary journal volume;
calculating an average throughput of write operations per unit time;
using the information calculated in the two preceding steps, determining an approximate consistency time.

23. A method as in claim 1 further comprising:
using a primary journal volume having a storage size to record changes made to the primary storage media;
at a desired time, determining usage of the primary journal volume; and
comparing the usage determined in the preceding step with the storage size of the primary volume to thereby obtain a usage ratio of the primary journal volume.

24. A method as in claim 5 wherein the step of monitoring WRITE operations further includes providing a remote probe in the remote site.

25. A method as in claim 5 wherein the storage system includes a plurality of storage systems, and a remote copy auditor stores measurements from the plurality of storage systems,
